(19) United States
(12) Patent Application Publication
(10) Pub. No.: US 2006/0076772 A1
(43) Pub. Date: Apr. 13, 2006

(54) Medical disconnection guard

(76) Inventor: Andrew Zimmerman, East Sussex (GB)

Correspondence Address: DIEDERIKS & WHITELAW, PLC, 12471 DILLINGHAM SQUARE, #301, WOODBRIDGE, VA, 22192, US

(21) Appl. No.: 10/508,041

(22) PCT Filed: Mar. 18, 2003
(86) PCT No.: PCT/GB03/01129

§ 371 Date: Jun. 20, 2005

(30) Foreign Application Priority Data
Mar. 19, 2002 (GB) 0206427.7
Aug. 12, 2002 (GB) 0218661.1

(51) Int. Cl. F16L 39/00

(52) U.S. Cl. 285/124.5; 604/500

(57) ABSTRACT

A medical disconnection guard 1 is disclosed comprising a plurality of fluid inlets 2 and a plurality of fluid outlets 3. The fluid inlets 2 are directly connected to the fluid outlets by fluid connectors 3a provided within a housing. In the event that an infusion line or monitoring line is accidentally pulled, the infusion line or monitoring line can come away from one side of the disconnection guard 1 whilst the patient remains connected to the disconnection guard 1 on the other side. The fluid inlets 2 and outlets 3 are preferably self-sealing.

The present invention relates to a disconnection guard for preventing the disconnection of infusion lines from a patient.

During major surgery a patient will usually have connected to them multiple infusion lines and monitoring leads. Due to sterile surgical fields and patient positioning, once the patient is positioned it is often difficult to gain access to these infusion lines. Access may be required for various reasons throughout surgery such as blood samples taken, addition/removal of equipment/infusion lines and bolus amounts of drugs to be given. Infusion supply lines are usually prepared prior to surgery and are connected to the patient during induction of anaesthesia. Extension lines and an access port are often added to the lines in order to solve the problem of reduced access due to patient positioning and avoiding disruption to the surgical field. However, this also lengthens the lines adding to the problem of lines becoming entangled and again increases the risk of trauma to the patient if the lines become caught on surrounding equipment.

GB 2,233,563 (Ainsworth) discloses a multiple interconnection apparatus for infusion lines which aims to provide an apparatus which allows the medical practitioner to increase the number of available infusion portals without increasing the number of insertion devices. The apparatus is designed to allow a greater number of inlet units to be connected to a lesser number of outlet units. The connection is provided by a flexible cross-connector tube and each outlet unit has a plurality of inlet ports to which can be connected more than one cross-connector tube. The tubes can be selectively rearranged which increases the risk of human error, and the introduction of infection into the infusion lines. The tubes connecting the inlet units and the outlet units are not housed and are therefore in a position to be rearranged or disturbed when in use.

According to one aspect of the present invention, there is provided a disconnection guard for preventing the disconnection of infusion lines from a patient, the disconnection guard comprising a plurality of fluid inlets, a plurality of fluid outlets, and one or more fluid connectors, each fluid connector connecting a fluid inlet to a fluid outlet and each fluid connector being fixedly and non-removably secured to the fluid inlet and to the fluid outlet.

The fluid connector is described as being fixed and non-removably secured between a fluid inlet and a fluid outlet. This should not be taken to mean that the fluid connector is incapable of being removed from between a fluid inlet and a fluid outlet, but simply that once the disconnection guard is assembled during manufacture the fluid connectors are not designed or intended to be removed from their position within the disconnection guard. Even if the fluid connectors can be detached from the fluid inlet and/or outlet, they are preferably of a length such that they can only be connected between a given inlet and a corresponding outlet. Accordingly, the preferred embodiment helps to prevent infusion lines being wrongly connected which is a significant problem with the arrangement disclosed in GB 2,233,563.

The disconnection guard provides a way of connecting infusion lines and electrical monitoring leads to a patient so that the patient is isolated from direct connection to surrounding equipment, and thus safeguarding the patient from possible trauma caused by pulled or tangled lines. The disconnection guard also provides a “point of reference” thereby enabling immediate access to all infusion lines for sampling, administration of bolus drugs, and addition/removal of equipment such as fluid warmers, as well as providing a common point of connection for electrical leads. The disconnection guard also reduces the risk of human error. For example, each fluid connector is kept separate and the apparatus does not allow connection between infusion lines.

The disconnection guard may be connected to infusion equipment whenever there are a plurality of infusion lines so that if at any time infusion lines are accidentally pulled, or caught on any equipment, tension in the infusion lines will only reach the disconnection guard and not the patient, thus avoiding possible trauma. The disconnection guard can be used wherever a patient has a plurality of infusion lines and/or electrical monitoring leads including operating theatres, Intensive Care Units (“ITUs”), coronary care, Magnetic Resonance Imaging etc.

Each fluid connector preferably connects a single fluid inlet to a single fluid outlet so as to prevent fluid from one infusion line from coming into contact with fluid from another infusion line. The disconnection guard therefore keeps the flow of liquid associated with each infusion line separate.

The disconnection guard preferably comprises two, three, four, five, six or more than six fluid inlets and/or fluid outlets.

The disconnection guard preferably has a plastic housing in which the fluid connectors are located and on which the fluid inlets and the fluid outlets are provided. The housing prevents access to the fluid connectors and, in particular, prevents changes being made to the arrangement of the fluid inlets, the fluid outlets and the fluid connectors thereby reducing the risk of human error. The housing also provides protection for the fluid inlets, the fluid outlets and the fluid connectors.

The disconnection guard may be arranged so that the fluid inlets are mounted on one side of the housing and the fluid outlets are mounted on an opposed side of the housing.

Each fluid connector preferably comprises plastic tubing. Furthermore, at least a majority of each fluid connector may be substantially transparent in order to allow the user to view the flow of fluid through the connector.

The disconnection guard may preferably have one or more viewing windows for providing a view of at least a portion of one or more of the fluid connectors. The viewing windows may, for example, comprise a flap or the viewing windows may comprise a transparent portion. Alternatively or additionally, at least a portion, preferably the whole, of the disconnection guard may be transparent so at least a portion of one or more of the fluid connectors is visible. It is advantageous to be able to view the fluid connectors before, during and after use so that a user can be confident that the flow of fluid through the apparatus is arranged correctly.

The disconnection guard may further comprise means for indicating which infusion line should be connected to a fluid inlet and/or a fluid outlet. The disconnection guard may, for example, be coloured or marked in a similar way to the corresponding infusion line to ensure the correct connection when connecting infusion lines to the disconnection guard. The uppermost surface of the disconnection guard may also have segmented markings indicating the corresponding fluid inlets and fluid outlets of the disconnection guard.

The disconnection guard may further comprise an attachment means for attaching the disconnection guard to a patients' bed, transfer trolley, stretcher, operating table or the like. Preferably, the attachment means comprises a strap.

The disconnection guard may further comprise one or more access ports. Each access port is in fluid connection with a fluid connector. The access port enables a fluid to be injected or otherwise introduced into a fluid connector and/or a fluid to be withdrawn from the fluid connector. The access ports provide immediate access to the infusion lines which can be needed at any time during use in order to take blood samples, to give bolus amounts of drugs or to change infusion liquids.

The disconnection guard may further comprise a valve selector device which allows fluid to flow from a fluid inlet to a fluid outlet, fluid to flow from an access port to a fluid outlet, fluid to flow from an access port to a fluid inlet without flowing to a fluid outlet, fluid to flow simultaneously from a fluid inlet and from an access port to a fluid outlet or fluid to flow from a fluid outlet to an access port without flowing to a fluid inlet. In one embodiment the selector device may comprise a three way valve. It is advantageous to be able to control the flow of fluid through the fluid connector and to and from the access port and fluid connector.

The disconnection guard may further comprise one or more flow control devices to selectively control the flow of fluid i.e. flow rate through the fluid connector.

The disconnection guard preferably further comprises means for preventing the disconnection of one or more electrical leads from a patient. The electrical leads may, for example, comprise a lead connected to an electrocardiograph (“ECG”) sensor and/or monitor or a lead connected to an oxygen saturation sensor and/or monitor.

According to a preferred embodiment, one or more plugs or sockets from one or more electrical leads may also be received in use within or on the disconnection guard. For example, the plug and socket may be located within a recess within the disconnection guard. According to this embodiment, electrical monitoring apparatus would be connected to a lead having a plug (socket). The plug (socket) would mate with a socket (plug) connected to another lead which was connected to a sensor attached to the patient. The plug and socket are preferably clamped to the disconnection guard. Therefore, if the lead attached to the electrical monitoring apparatus was accidentally pulled, the plug and socket would separate but the lead attached to the patient would essentially be undisturbed.

According to a less preferred embodiment, the electrical monitoring equipment may be directly connected to a patient sensor without there being an intermediate plug/socket. In such circumstances the monitoring lead is clamped to the disconnection guard and the lead may be arranged to come away from the monitoring equipment in the event that the lead is accidentally pulled.

The disconnection guard may further comprise one or more clamps for securing one or more leads, plugs or sockets within or on the disconnection guard.

The fluid inlets preferably comprise push-on couplings such as luer-slip fittings for connection to infusion lines. The couplings therefore allow infusion lines connected to the couplings to come away from the fluid inlets in the event that an infusion line is accidentally pulled or becomes tangled or pulled. This prevents causing the patient any trauma.

Whereas the connections to the fluid inlets of the disconnection guard preferably deliberately allow for infusion lines to come away from the inlet connector in the event that they are accidentally pulled, the fluid outlets preferably comprise locking (e.g. screw) couplings for connection of the infusion lines which run from the disconnection guard to the patient. Preferably, the locking couplings comprise luer-lock couplings. The fluid outlets preferably comprise couplings which substantially prevent infusion lines connected to the couplings coming away from the fluid outlets in the event that an infusion line is pulled.

In the present application the term “fluid inlet coupling” is used to describe a coupling which normally connects infusion equipment such as gravity-fed infusion devices or syringe drivers to the disconnection guard. Similarly, the term “fluid outlet coupling” is used to describe a coupling which normally connects the disconnection guard to an infusion line which is directly connected to the patient.

The fluid inlets and less preferably the fluid outlets may comprise substantially self-sealing couplings thereby preventing fluids and/or blood leaking out. The couplings also substantially prevent air from entering the infusion lines should the infusion lines become disconnected, either intentionally or accidentally.

The disconnection guard may further comprise one or more clips for securing one or more additional infusion lines such as Epidural lines. It is important that Epidural lines are kept separate from infusion lines so as to ensure that drugs are not accidentally introduced in to an Epidural line rather than in to an infusion line. The separate clips help to reduce the chance of an Epidural line becoming tangled whilst also ensuring that the Epidural line is not mistaken for an infusion line.

According to a further aspect of the invention, there is provided a disconnection guard for preventing the disconnection of infusion and electrical lines from a patient, the disconnection guard comprising means for securing one or more electrical connectors, a plurality of fluid inlets, a plurality of fluid outlets and a plurality of fluid connectors, each fluid connector connecting a fluid inlet to a fluid outlet, each fluid connector being fixedly and non-removably secured to the fluid inlet and to the fluid outlet wherein each fluid connector comprises a self-sealing access port through which a fluid may be introduced into and/or withdrawn from the fluid connector.

According to a further aspect of the invention, there is provided a fluid disconnection guard for preventing the disconnection of infusion lines from a patient, the disconnection guard comprising a plurality of fluid inlets, a plurality of fluid outlets and a plurality of fluid connectors, each fluid connector connecting a single fluid inlet to a single fluid outlet and each fluid connector being fixedly and non-removably secured to the fluid inlet and to the fluid outlet.

According to a further aspect of the invention, there is provided medical infusion equipment comprising one or more infusion devices for supplying one or more infusion fluids, a disconnection guard, and a plurality of infusion lines connecting the one or more infusion devices with the disconnection guard wherein the disconnection guard comprises a plurality of fluid inlets, a plurality of fluid outlets and a plurality of fluid connectors, each fluid connector connecting a single fluid inlet to a single fluid outlet and each fluid connector being fixedly and non-removably secured to the fluid inlet and to the fluid outlet.

The medical infusion equipment preferably further comprises one or more electrical monitoring devices and means for securing one or more electrical connectors and/or leads attached to one or more sensors to the disconnection guard.

According to a further aspect of the invention, there is provided a disconnection guard for preventing the disconnection of infusion lines from a patient, the disconnection guard comprising a housing, a plurality of fluid inlets and fluid outlets mounted on the housing and a plurality of substantially transparent fluid connectors provided within the housing, each fluid connector connecting a fluid inlet to a fluid outlet wherein the housing comprises a transparent portion so that at least a portion of the fluid connectors is viewable through the transparent portion.

According to a further aspect of the invention, there is provided a method of preventing the disconnection of infusion lines comprising: providing a disconnection guard comprising a plurality of fluid inlets, a plurality of fluid outlets, and at least one fluid connector connecting a fluid inlet to a fluid outlet, the fluid connector being fixedly and non-removably secured to the fluid inlet and to the fluid outlet; attaching the disconnection guard to a patient's bed, transfer trolley, stretcher or operating table; and attaching one or more infusion devices to the disconnection guard.

The method may further comprise attaching one or more infusion lines from the disconnection guard to a patient.

According to a further aspect of the invention, there is provided a method of transferring a patient comprising: disconnecting infusion equipment from a disconnection guard; moving a patient, the patient being connected to the disconnection guard by infusion lines; and connecting transit infusion equipment to the disconnection guard; wherein the disconnection guard comprises a plurality of fluid inlets, a plurality of fluid outlets, and at least one fluid connector connecting a fluid inlet to a fluid outlet, the fluid connector being fixedly and non-removably secured to the fluid inlet and to the fluid outlet.

Preferably, the method further comprises: disconnecting electrical leads from the disconnection guard prior to moving the patient; and connecting transit monitoring equipment to the disconnection guard; wherein the step of moving the patient comprises moving the patient whilst the patient is additionally connected to one or more electrical leads.

According to a further aspect of the invention, there is provided a disconnection guard for preventing the disconnection of infusion lines from a patient, the disconnection guard comprising: a housing, a plurality of fluid inlets and fluid outlets mounted on the housing and one or more fluid connectors provided in the housing, each fluid connector connecting a single fluid inlet to a single fluid outlet.

Although according to the preferred embodiment the disconnection guard comprises a housing wherein fluid connectors are protected within said housing, accordingly to less preferred embodiments the fluid inlets, outlets and connectors may be provided on a substantially flat board. According to a yet further aspect of the invention, there is provided a disconnection guard for preventing the disconnection of infusion lines from a patient, the disconnection guard comprising: a board, a plurality of fluid inlets and fluid outlets mounted on the board and one or more fluid connectors provided on the board, each fluid connector connecting a single fluid inlet to a single fluid outlet.

Various embodiments of the present invention will now be described, by way of example only, and with reference to the accompanying figures in which:

FIG. 1 shows a plan view of a disconnection guard according to the preferred embodiment;

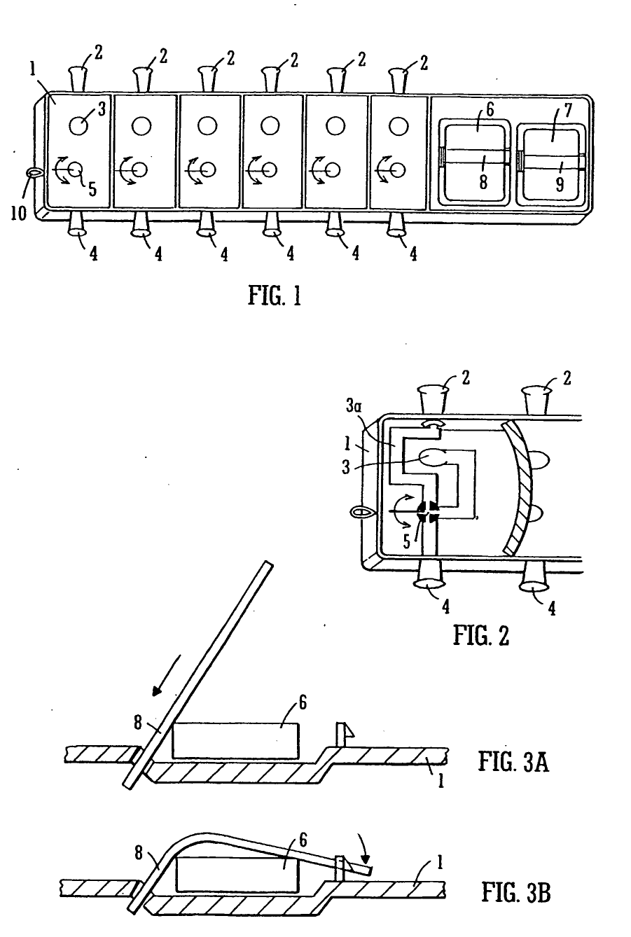

FIG. 2 shows a rear view of the disconnection guard with part of the housing removed showing a fluid connector according to the preferred embodiment;

FIG. 3 shows a cross-sectional view of the disconnection guard according to the preferred embodiment with a means for clamping one or more plugs;

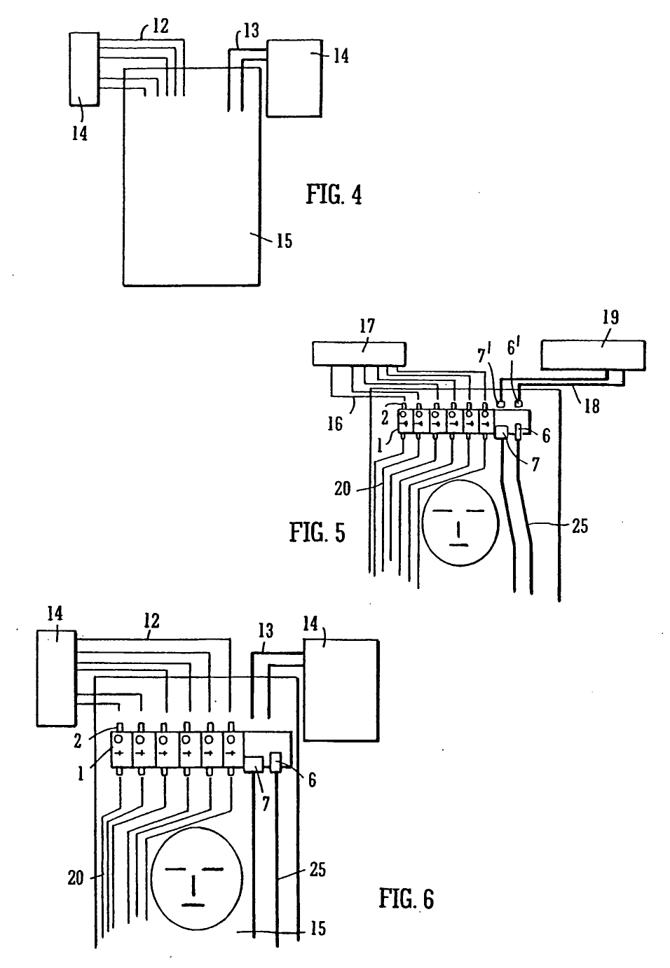

FIG. 4 shows a transfer trolley together with transit monitoring equipment and leads, and transit infusion equipment and lines appropriately routed;

FIG. 5 shows a patient on a bed, a disconnection guard according to the preferred embodiment, and the positioning of infusion/monitoring equipment lines and leads;

FIG. 6 shows a patient on a transfer trolley, a disconnection guard according to the preferred embodiment, and transit monitoring and infusion equipment;

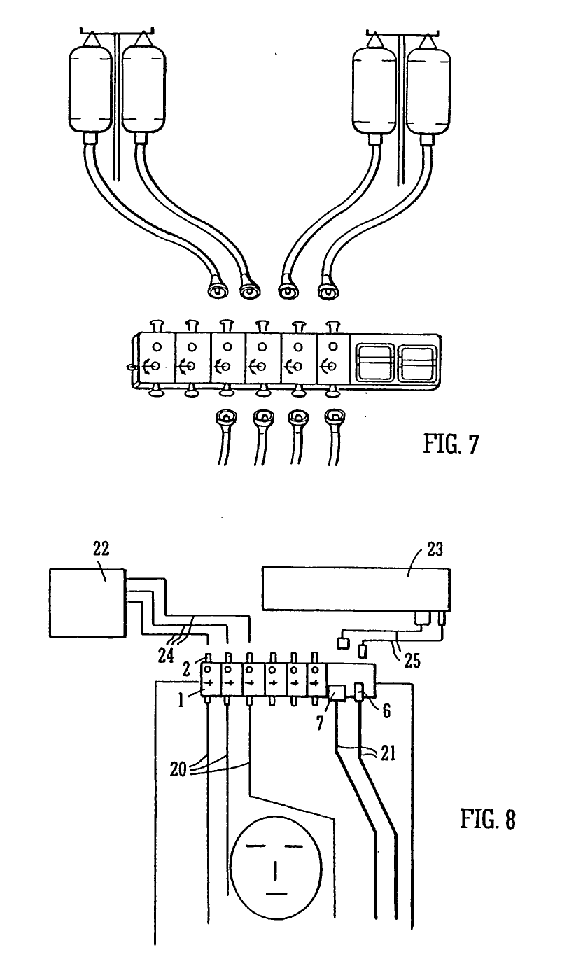

FIG. 7 shows how gravity fed infusion devices may be connected to a disconnection guard according to the preferred embodiment; and

FIG. 8 shows a patient on an operating table, a disconnection guard according to the preferred embodiment, and the positioning of infusion/monitoring equipment lines and leads.

A preferred disconnection guard will now be described with reference to FIG. 1. The disconnection guard 1 in one embodiment comprises six fluid inlets 2 and six fluid outlets 4. A fluid connector (not shown) within the housing connects a fluid inlet 2 to a fluid outlet 4. An access port 3 may be provided for each fluid connector. A three way valve 5 is preferably provided which enables the flow of fluid through the device to be controlled. Plugs 6,7 may be secured to the disconnection guard by clamps 8,9. Infusion lines (not shown) from infusion equipment (not shown) are preferably provided with a male connection which connects to fluid inlets 2 which have a self-sealing female connection. Infusion lines (not shown) connecting the disconnection guard 1 to the patient are preferably provided with female seal-sealing connectors for connecting to fluid outlets 4 which are preferably provided with male connections. The male connections are not self-sealing.

FIG. 2 shows a rear view of part of the disconnection guard 1. The fluid inlets 2 and fluid outlets 4 can be seen to be directly connected to each other by a fluid connector 3a. Access port 3 is shown as being in fluid connection with the fluid connector 3a and the three way valve 5.

FIG. 3 shows a cross-sectional view of the disconnection guard 1 and shows in particular how a plug 6 connected to an electrical monitoring lead may be secured to the disconnection guard 1 by a clamp 8.

FIG. 4 shows a transfer trolley 15 prior to moving a patient. Transit infusion supply lines 12 and electrical monitoring leads 13 extend from transit infusion and monitoring equipment 14 to which the patient will be connected whilst in transit. The transit infusion supply lines 12 are appropriately routed so that they are ready to be connected to a disconnection guard 1 once the patient has been moved to the transfer trolley 15.

FIG. 5 shows a patient on the transfer trolley 15 still connected to Intensive Care Unit (“ITU”) infusion equipment 17 and ITU monitors 19 via a disconnection guard 1. The ITU infusion equipment 17 is shown connected to fluid inlets 2 on the disconnection guard 1 by infusion lines 16. Other infusion lines 20 are shown running from the disconnection guard 1 and will be connected to the patient. The ITU monitors 19 are connected to the patient by electrical monitoring leads 18,25 via intermediate plugs 6,7 and sockets 61,71 which are secured to the disconnection guard 1 by clamps 8,9. When moving the patient, the infusion supply lines 16 to which the disconnection guard 1 was connected are disconnected from their relevant fluid inlets 2 on the disconnection guard 1. The electrical monitoring leads 18 extending from the ITU monitors 19 to which the patient is currently connected are likewise unplugged from the plugs 6,7. The patient is then moved from a bed to the transfer trolley 15. The disconnection guard 1, and the infusion lines 20 and electrical leads 21 which connect the patient to the disconnection guard 1 are moved with the patient.

FIG. 6 shows the patient when immediately transferred to the transfer trolley 15. The disconnection guard 1, the infusion lines 20 and the electrical monitoring leads 25 which are transferred with the patient remain in place and transit infusion and monitoring equipment 14 are then connected to the fluid inlets 2 and the plugs 6,7 situated on the disconnection guard 1 by transit infusion lines 12 and transit electrical monitoring leads 13 respectively. It is preferable for the disconnection guard 1 to be situated and remain at the head of the patient throughout the manoeuvre and for the infusion lines from the disconnection guard 1 to remain connected to the patient.

FIG. 7 shows infusion supply lines from a plurality of gravity fed infusion devices. The infusion supply lines may include CVP and Arteriole pressure transducing lines which are prepared and primed in a conventional manner. However, these are not connected directly to the patient but are connected to the relevant inlet connectors 2 on the disconnection guard 1. Patient supply infusion lines are connected to the relevant outlet connectors 4 and once primed are connected to the patient during induction of anaesthesia. Infusion fluid may also be supplied by other means to the disconnection guard 1 such as, for example, by way of one or more syringe drivers.

FIG. 8 shows a patient who has been transferred from a transfer trolley 15 to an operating table. The transit infusion and monitoring equipment 14 shown in FIG. 6 can be replaced with theatre infusion equipment 22 and theatre monitoring equipment 23.

Connecting the patient to the theatre monitors 23 and theatre infusion equipment 22 via the disconnection guard 1 prior to surgical preparation allows immediate access to infusions to be gained via the access ports 3 without causing disruption to the surgical team or the patient during surgery. When the surgery is completed the theatre infusion supply lines 24 are disconnected from the fluid inlets 2 and the plugs 6,7 are released from the disconnection guard 1. The disconnection guard 1 remains connected to the patient via infusion lines 20 and is used to connect the patient to monitors/infusion equipment thereafter.

1. A disconnection guard for preventing the disconnection of infusion lines from a patient, said disconnection guard comprising:
a plurality of fluid inlets;
a plurality of fluid outlets; and
one or more fluid connectors, each said fluid connector connecting a fluid inlet to a fluid outlet and each said fluid connector being fixedly and non-removably secured to said fluid inlet and to said fluid outlet.

2. A disconnection guard as claimed in claim 1, wherein each said fluid connector connects a single fluid inlet to a single fluid outlet.

3. A disconnection guard as claimed in claim 1, wherein said disconnection guard comprises two, three, four, five, six or more than six fluid inlets and/or fluid outlets.

4. A disconnection guard as claimed in claim 1, further comprising a housing, wherein said fluid connectors are located within said housing and wherein said fluid inlets and said fluid outlets are provided on said housing.

5. A disconnection guard as claimed in claim 4, wherein said fluid inlets are mounted on one side of said housing and said fluid outlets are mounted on an opposed side of said housing.

6. A disconnection guard as claimed in claim 1, wherein each said fluid connector comprises plastic tubing.

7. A disconnection guard as claimed in claim 1, wherein at least a majority of each said fluid connector is substantially transparent.

8. A disconnection guard as claimed in claim 1, wherein said disconnection guard comprises one or more viewing windows for providing a view of at least a portion of one or more of said fluid connectors.

9. A disconnection guard as claimed in claim 1, wherein at least a portion of said disconnection guard is transparent so at least a portion of one or more of said fluid connectors is visible.

10. A disconnection guard as claimed in claim 1, further comprising means for indicating which infusion line should be connected to a fluid inlet and/or a fluid outlet.

11. A disconnection guard as claimed in claim 1, further comprising attachment means for attaching said disconnection guard to a patients' bed, transfer trolley, stretcher, operating table or the like.

12. A disconnection guard as claimed in claim 11, wherein said attachment means comprises a strap.

13. A disconnection guard as claimed in claim 1, wherein said disconnection guard further comprises one or more access ports, each said access port being in fluid connection with a said fluid connector.

14. A disconnection guard as claimed in claim 13, wherein each said access port enables a fluid to be injected or otherwise introduced into a fluid connector and/or a fluid to be withdrawn from said fluid connector.

15. A disconnection guard as claimed in claim 13, wherein each said access port is substantially self-sealing.

16. A disconnection guard as claimed in claim 13, further comprising a selector device which allows one or more of the following: (i) fluid to flow from a fluid inlet to a fluid outlet; (ii) fluid to flow from an access port to a fluid outlet; (iii) fluid to flow from an access port to a fluid inlet without flowing to a fluid outlet; (iv) allowing fluid to flow simultaneously from a fluid inlet and from an access port to a fluid outlet; and (iv) fluid to flow from a fluid outlet to an access port without flowing to a fluid inlet.

17. A disconnection guard as claimed in claim 1, wherein said disconnection guard further comprises one or more flow control devices, each said flow control device being used to selectively control the flow of fluid through a fluid connector.

18. A disconnection guard as claimed in claim 17, wherein each said flow control device comprises a three way valve.

19. A disconnection guard as claimed in claim 1, wherein said disconnection guard further comprises means for preventing the disconnection of one or more electrical leads from a patient.

20. A disconnection guard as claimed in claim 19, wherein said one or more electrical leads are selected from the group consisting of: (i) a lead connected to an electrocardiograph (“ECG”) sensor and/or monitor; and (ii) a lead connected to an oxygen saturation sensor and/or monitor.

21. A disconnection guard as claimed in claim 19, wherein one or more plugs or sockets from one or more electrical leads are received in use within or on said disconnection guard.

22. A disconnection guard as claimed in claim 19, further comprising one or more clamps for securing one or more leads, plugs or sockets within or on said disconnection guard.

23. A disconnection guard as claimed in claim 1, wherein said fluid inlets comprise push-on couplings for connection to an infusion line.

24. A disconnection guard as claimed in claim 23, wherein said push-on couplings comprise luer-slip couplings.

25. A disconnection guard as claimed in claim 1, wherein said fluid inlets comprise couplings which allow infusion lines connected to said couplings to come away from said fluid inlets in the event that an infusion line is pulled.

26. A disconnection guard as claimed in claim 1, wherein said fluid outlets comprise locking couplings for connection to an infusion line.

27. A disconnection guard as claimed in claim 26, wherein said locking couplings comprise luer-lock couplings.

28. A disconnection guard as claimed in claim 1, wherein said fluid outlets comprise couplings which substantially prevent infusion lines connected to said couplings coming away from said fluid outlets in the event that an infusion line is pulled.

29. A disconnection guard as claimed in claim 1, wherein said fluid inlets and/or said fluid outlets comprise substantially self-sealing couplings.

30. A disconnection guard as claimed in claim 1, further comprising one or more clips for securing one or more additional infusion lines.

31. A disconnection guard for preventing the disconnection of infusion and electrical lines from a patient, said disconnection guard comprising:
means for securing one or more electrical connectors;
a plurality of fluid inlets;
a plurality of fluid outlets; and
a plurality of fluid connectors, each fluid connector connecting a fluid inlet to a fluid outlet, each said fluid connector being fixedly and non-removably secured to said fluid inlet and to said fluid outlet;
wherein each said fluid connector comprises a self-sealing access port through which a fluid may be introduced into and/or withdrawn from said fluid connector.

32. A fluid disconnection guard for preventing the disconnection of infusion lines from a patient, said disconnection guard comprising:
a plurality of fluid inlets;
a plurality of fluid outlets; and
a plurality of fluid connectors, each fluid connector connecting a single fluid inlet to a single fluid outlet and each said fluid connector being fixedly and non-removably secured to said fluid inlet and to said fluid outlet.

33. Medical infusion equipment comprising:
one or more infusion devices for supplying one or more infusion fluids;
a disconnection guard; and
a plurality of infusion lines connecting said one or more infusion devices with said disconnection guard;
wherein said disconnection guard comprises a plurality of fluid inlets, a plurality of fluid outlets and a plurality of fluid connectors, each said fluid connector connecting a single fluid inlet to a single fluid outlet and each said fluid connector being fixedly and non-removably secured to said fluid inlet and to said fluid outlet.

34. Medical infusion equipment as claimed in claim 33, further comprising one or more electrical monitoring devices and wherein said disconnection guard further comprises means for securing one or more electrical connectors and/or leads attached to one or more sensors to said disconnection guard.

35. A disconnection guard for preventing the disconnection of infusion lines from a patient, said disconnection guard comprising:
a housing;
a plurality of fluid inlets and fluid outlets mounted on said housing; and
a plurality of substantially transparent fluid connectors provided within said housing, each said fluid connector connecting a fluid inlet to a fluid outlet;
wherein said housing comprises a transparent portion so that at least a portion of said fluid connectors is viewable through said transparent portion.

36. A method of preventing the disconnection of infusion lines comprising:
providing a disconnection guard comprising a plurality of fluid inlets, a plurality of fluid outlets, and at least one fluid connector connecting a fluid inlet to a fluid outlet, said fluid connector being fixedly and non-removably secured to said fluid inlet and to said fluid outlet;
attaching said disconnection guard to a patient's bed, transfer trolley, stretcher or operating table; and
attaching one or more infusion devices to said disconnection guard.

37. A method as claimed in claim 36, further comprising attaching one or more infusion lines from said disconnection guard to a patient.

38. A method of transferring a patient comprising:
disconnecting infusion equipment from a disconnection guard;
moving a patient, said patient being connected to said disconnection guard by infusion lines; and
connecting transit infusion equipment to said disconnection guard;
wherein said disconnection guard comprises a plurality of fluid inlets, a plurality of fluid outlets, and at least one fluid connector connecting a fluid inlet to a fluid outlet, said fluid connector being fixedly and non-removably secured to said fluid inlet and to said fluid outlet.

39. A method as claimed in claim 38, further comprising:
disconnecting electrical leads from said disconnection guard prior to moving said patient; and
connecting transit monitoring equipment to said disconnection guard;
wherein the step of moving said patient comprises moving said patient whilst said patient is additionally connected to one or more electrical leads.

40. A disconnection guard for preventing the disconnection of infusion lines from a patient, said disconnection guard comprising:
a housing;
a plurality of fluid inlets and fluid outlets mounted on said housing; and
one or more fluid connectors provided in said housing, each said fluid connector connecting a single fluid inlet to a single fluid outlet.

41. A disconnection guard for preventing the disconnection of infusion lines from a patient, said disconnection guard comprising:
a board;
a plurality of fluid inlets and fluid outlets mounted on said board; and
one or more fluid connectors provided on said board, each said fluid connector connecting a single fluid inlet to a single fluid outlet.
